(19) United States
(12) Patent Application Publication
(10) Pub. No.: US 2008/0165466 A1
(43) Pub. Date: Jul. 10, 2008

(54) Method and Apparatus For Providing a Carbon Nanotube Plasma Limiter Having a Subnanosecond Response Time

(76) Inventors: Luke Timothy Gritter, Chattanooga, TN (US); Peter George Krueger, Ooltewah, TN (US); Clifton James Murphy, Chattanooga, TN (US); Robert Michael Pap, Chattanooga, TN (US)

Correspondence Address: David W. Lynch;Chambliss, Bahner & Stophel P.C., Two Union Square, 1000 Tallan Building, Chattanooga, TN, 37402, US

(21) Appl. No.: 11/620,414

(22) Filed: Jan. 5, 2007

(51) Int. Cl. H02H 1/04

(52) U.S. Cl. 361/120; 977/948

(57) ABSTRACT

A method and apparatus for providing a carbon nanotube array plasma limiter having a subnanosecond response time is disclosed. A transmission line assembly having a signal line is provided. A carbon nanotube device is coupled to the transmission line assembly across a gap, wherein the carbon nanotube device is configured for enhancement of an electric field, to initiate a streamer breakdown process within the gap to cause a short circuit of the transmission line assembly in response to a predetermined energy pulse.

### GOVERNMENT INTERESTS

Certain claims recited herein were developed under a Small Business Innovation Research (SBIR) project funded by the U.S. Government as represented by the Missile Defense Agency under SMD Contract No. W9113M-05-C-0172. The U.S. Government has certain rights in the invention.

### BACKGROUND OF THE INVENTION

1. Field of the Invention

This invention relates in general to transient overvoltage protection devices, and more particularly to a method and apparatus for providing a carbon nanotube plasma limiter having a subnanosecond response time.

2. Description of Related Art

Semiconductor components in modern radar systems render the electronics susceptible to damage or upset by electromagnetic interference (EMI). More particularly, semiconductor technology in radar systems increases the vulnerability of a component to the effects of high-power, fast rise-time electromagnetic pulses (EMP), high power microwave (HPM), and ultra wide band (UWB) pulses. Significant advances in the technology used to produce these high-power, short pulses have been made in the past few decades, and the proliferation of nuclear capabilities has increased the danger of an EMP from a nuclear burst. EMP, HPM and UWB generation techniques have matured sufficiently to deploy electromagnetic weapons using a number of delivery techniques to generate an intense, short duration electromagnetic pulse whose powerful electromagnetic field produces damaging transient voltages in electrical components. Military and civilian systems with unprotected electronic equipment can be rendered useless by such devices. As a result, the need for devices that can protect sensitive electronic equipment from these pulses is greater than ever.

Conventional protection techniques, such as gas arrestors and diode limiters, shield electronic devices effectively from EMI produced by static discharge and lightning induced transient overvoltages. Such pulses are characterized by their slow risetime (˜100 nsec) and long pulse widths (˜10 μsec). A short pulse directed energy weapon (DEW) generating high power microwaves (HPM) with risetimes less than 1 nanosecond can render conventional protection devices ineffective with disastrous effects.

As mentioned above, the electromagnetic threat environment is also driven by flourishing nuclear capabilities in uncooperative countries, and includes the resultant threat of an electromagnetic pulse (EMP) from a nuclear burst. A nuclear detonation gives rise to an intense electromagnetic pulse from Compton electrons generated by released gamma rays. These electrons produce an intense radiating field that propagates through the atmosphere, which can couple into transmission lines, diffuse through shields and leak through apertures such as seams, joints and windows.

Current military systems require modifications to attain protection against electromagnetic attacks, and future systems must be hardened during their design phase. Gas discharge and/or solid-state devices have been used in the past. However, standard gas discharge and/or solid-state devices fail to protect against rapid rise-time, high-energy pulses. Gas discharge devices have high power protection capability but slow response times. Conversely, solid-state devices, such as silicon avalanche diodes and metal-oxide varistors, have extremely fast turn-on times but are damaged by high power levels.

In an effort to meet the need for protection against these threats, plasma limiters have been developed. A plasma limiter uses a highly overvoltaged spark gap to combine high power handling capability with fast reaction time. Plasma occurs when a substance such as a gas is excited to a high-energy state in which electrons are freed from their nuclei, resulting in negatively charged electrons and positive ions. The plasma is highly conductive and acts as a channel in the limiter to shunt damaging overvoltage pulses to ground.

For the plasma limiter device to operate effectively, it must turn-on as fast as possible to allow minimum transmission of damaging power. Currently, metallic needles are used in plasma limiters to protect sensitive electronic equipment from high transient voltages caused by EMP, HPM and UWB pulses. However, field enhancement, higher power handling capability, and long-term reliability of metallic needles can be improved with use of carbon nanotube (CNT) electrodes. Metallic needles also fail to facilitate a reduction in size of plasma limiters. Also, conventional metal electrodes become corroded or in some cases covered in deposits that dramatically reduce their performance, reliability, and useful life. Further, the configuration of such electrodes in a plasma limiter requires the use of adhesive materials thereby complicating the assembly process.

It can be seen that there is a need for a method and apparatus for providing a plasma limiter having a subnanosecond response time using improved electrodes.

### SUMMARY OF THE INVENTION

To overcome the limitations in the prior art described above, and to overcome other limitations that will become apparent upon reading and understanding the present specification, the present invention discloses a method and apparatus for providing a carbon nanotube plasma limiter having a subnanosecond response time.

The present invention solves the above-described problems by providing a carbon nanotube plasma limiter implemented using carbon nanotube electrodes.

A carbon nanotube plasma limiter in accordance with the principles of the present invention includes a transmission line assembly having a signal line and a carbon nanotube device, coupled to the transmission line assembly across a gap, configured for enhancing an electric field to initiate a streamer breakdown process within the gap to cause a short circuit of the transmission line assembly in response to a predetermined energy pulse.

In another embodiment of the present invention, a method for providing a carbon nanotube plasma limiter is provided. The method includes providing a transmission line assembly having a signal line, providing a carbon nanotube device to form a gap between the carbon nanotube device and the signal line of the transmission line assembly and configuring the carbon nanotube device for enhancing an electric field to initiate a streamer breakdown process within the gap to cause a short circuit of the transmission line assembly in response to a predetermined energy pulse.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

Referring now to the drawings in which like reference numbers represent corresponding parts throughout:

FIGS. 1a-c show a plasma limiter in a microwave transmission line receiving a fixed frequency microwave signal;

FIGS. 2a-d show temporal development of a streamer discharge according to an embodiment of the present invention;

FIG. 3 shows a set of Paschen curves that demonstrate the existence of a minimum in the breakdown voltage for a certain pressure and gap distance according to an embodiment of the present invention;

FIG. 4 shows an image of a carbon nanotube array for use in a plasma limiter according to an embodiment of the present invention;

FIG. 5 shows a cross-section of a plasma limiter implemented as a shielded microstrip line with a CNT array according to an embodiment of the present invention; and

FIG. 6 is a crossection of a plasma limiter implemented as a coaxial cable with a CNT array according to an embodiment of the present invention.

### DETAILED DESCRIPTION OF THE INVENTION

In the following description of the embodiments, reference is made to the accompanying drawings that form a part hereof, and in which is shown by way of illustration the specific embodiments in which the invention may be practiced. It is to be understood that other embodiments may be utilized because structural changes may be made without departing from the scope of the present invention.

The present invention provides a method and apparatus for providing a carbon nanotube plasma limiter having a subnanosecond response time. A carbon nanotube plasma limiter is implemented using carbon nanotube electrodes.

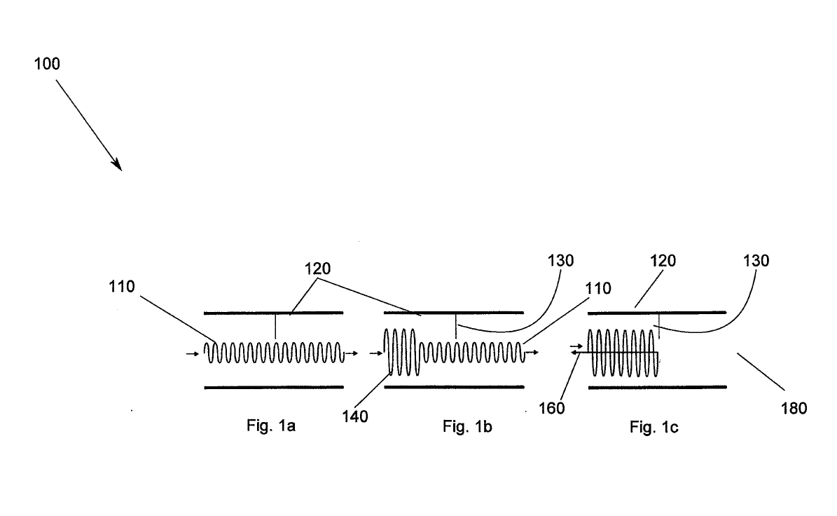

FIGS. 1a-c show a plasma limiter 100 in a microwave transmission line receiving a fixed frequency microwave signal. In FIG. 1a, microwaves 110 are shown propagated through the transmission line 120. The plasma limiter is an encapsulated device with a point-plane electrode 130. As described earlier, a point electrode may be provided using an extremely sharp metallic needle with a very fine point, ≈1 μm (10⁻⁶ meter) diameter, mounted to one of the parallel plates in a low-pressure gas medium. FIG. 1(b) shows an incident HPM 140 propagating along the transmission line 120 before the plasma limiter 100 has discharged. FIG. 1c shows the HPM 140 reaching the plasma limiter electrode 130, wherein a discharge occurs (ideally, instantaneously) and all of the incident HPM 140 is reflected 160. A standing wave occurs before the limiter along the transmission line 120. This protects the sensing equipment at the downstream end 180 of the transmission line 120 from the potentially damaging microwave radiation.

However, for a plasma limiter device to operate effectively, it must turn-on as fast as possible to allow minimum transmission of damaging power. To improve this turn-on time, the processes, which lead to the complete discharge or breakdown of the plasma limiter, must be understood. In the highly overvoltaged, low pressure and nanosecond time regimes, the two processes that lead to breakdown are electron field emission and streamer discharge.

First, free electrons must exist within the gap before any breakdown process can initiate. These electrons may be created within the gap by a variety of means, including UV radiation, radioactive decay, or cosmic rays. UV radiation and radioactive decay call for some active pre-ionization and cosmic rays occurs naturally, but are accompanied by significant statistical time delays.

Another mechanism by which electrons may be introduced into the gap is by field emission. When the electric field at the cathode is extremely high, it will pull the electrons away, transforming the potential well into a potential barrier of finite width. As a result, the electrons escape the metal cathode by tunneling. There is essentially no statistical delay with this process and no active devices. The high electric field at the cathode is a result of the applied electric field and the electric field enhancements due to the fine point geometry of the cathode.

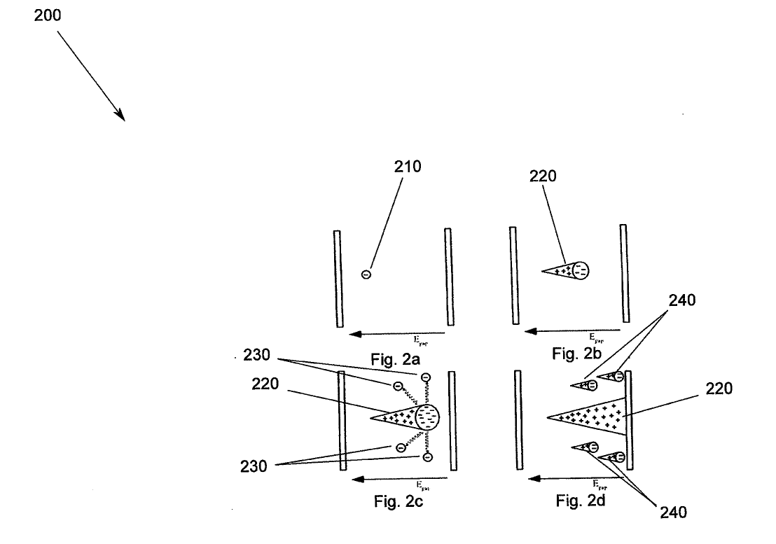

FIGS. 2a-d show temporal development of a streamer discharge 200 according to an embodiment of the present invention. Once the electrons are introduced into the gap, a streamer discharge begins to take place. However, to understand the streamer discharge process, the mechanisms of electrical breakdown must first be understood.

Electrical breakdown refers to the Townsend breakdown mechanism, which is named for J. S. Townsend who first proposed the general description. Townsend breakdown starts with a free electron located somewhere between the pair of electrodes. When an electric field is applied between the electrodes, the free electron experiences a force. The force due to the electric field accelerates the electron until it collides with a neutral atom or molecule. If the electron has gained enough kinetic energy, the collision is inelastic and the neutral atom is ionized. The collision results in two free electrons and one positive ion. The process then starts over and the two electrons become four, and so on. This process is known as an electron avalanche. If enough avalanches occur over a period of time, the gas temperature increases thereby lowering the channel resistance. The gap resistance then drops to a point where the electrical driving circuit heats the channel more efficiently. The gap resistance then drops rapidly along with the gap voltage to very low values at which time complete electrical breakdown is said to have occurred.

Many, but not all, of the processes observed in gaseous breakdown can be explained using the Townsend mechanism. However, the Townsend mechanism falls short in explaining breakdown in overvoltaged gaps (gaps in which the applied voltage is >20% of the DC breakdown voltage). There are two processes that occur in overvoltaged gaps that the Townsend mechanism does not consider. The first process is photoemission with photo-ionization. As the electron avalanches are forming and growing some of the metastable states return to ground state, in the process emitting energetic photons. These photons may be absorbed by neutrals and/or excited states resulting in ionization.

Another process not considered is the self-generated electric field of the space charge in the avalanche. As the avalanche increases in numbers of electrons, so does its self-generated electric field, increasing linearly. When the magnitude of the self-generated electric field reaches the order of the external electric field due to the gap voltage, significant changes in electron energies and ionization will occur locally.

Photoemission, photo-ionization, and the development of an intense electric field due to space charge are processes that dominate streamer discharge. A streamer discharge starts out much like a Townsend breakdown with an initial electron avalanche. At high electric fields and moderate pressures the electron avalanche will grow, such that the self generated electric field at the head of the avalanche becomes on the order of the electric field across the gap. This self-generated electric field causes locally intense ionization at the head of the avalanche. This ionization results in photoemission and photo-ionization that develop into additional electron avalanches.

Returning to FIGS. 2a-d, FIG. 2a shows an initial free electron 210. In FIG. 2b, an initial electron avalanche 220 is shown. FIG. 2c shows the buildup of an intense electric field 230 due to space charge starting photoemission. Finally, FIG. 2d shows the initial electron avalanche 220 multiplying into multiple electron avalanches 240.

The temporal development of streamers is a very fast process. Streamer velocities can be as high as 4×10⁶ M/s, or 1.3% the speed of light. Streamers can cross 1 cm gaps in <1 nsec, dependent upon the magnitude of the applied voltage, gas pressure, and the non-uniformity of the E-field. Once the streamer crosses the gap, a complex thermal process takes place that increases the channel conductivity. At this time, the discharge is fully developed and the gap is considered to be active. These three processes, i.e., electron field emission, streamer discharge and increased channel conductivity, can take place in less than a nanosecond if the electric field across the gap and near the cathode is high enough.

Once the applied voltage is removed, the gas within the gap requires a finite period of time to return to its natural state as before ionization. This is commonly referred to as the relaxation time and depends in part on the particular ionized gas. Within the gas itself, deionization will occur predominately via diffusion, recombination, and attachment. For a plasma limiter, the relaxation time determines the recovery time of the overall system, i.e. when it can return to normal operation after discharging.

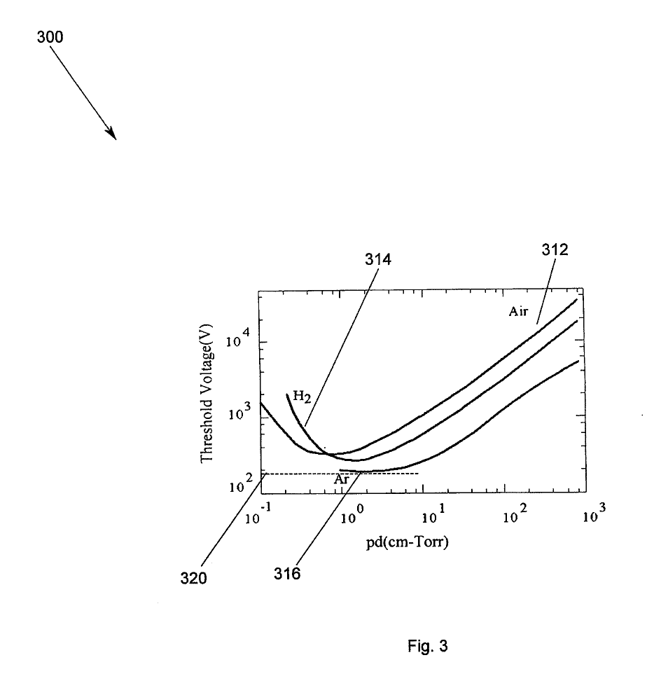

FIG. 3 shows a set of Paschen curves 300 that demonstrate the existence of a minimum in the breakdown voltage for a certain pressure and gap distance according to an embodiment of the present invention. The Paschen curves 300 include one curve for air 312, one curve for hydrogen 314, and one curve for argon 316. As can be seen, argon provides the lowest threshold breakdown voltage 320. Optimal limiter performance occurs when the gas pressure and limiter geometry are set in such a way as to minimize the breakdown voltage. Accordingly, a plasma limiter system includes extremely fast turn-on times (less than 1 nsec) while maintaining high power handling capability, simple geometry which can be integrated into existing equipment and active pre-ionization may not be necessary.

Nevertheless, as mentioned above, field enhancement, power handling capability, and long-term reliability of a limiter with metallic needles can be improved with use of CNT electrodes. Metallic needles also fail to facilitate a reduction in size of plasma limiters. Also, conventional metal electrodes become corroded or in some cases covered in deposits that dramatically reduce their performance, reliability, and useful life. Further, the configuration of such electrodes in a plasma limiter requires the use of adhesive materials thereby complicating the assembly process.

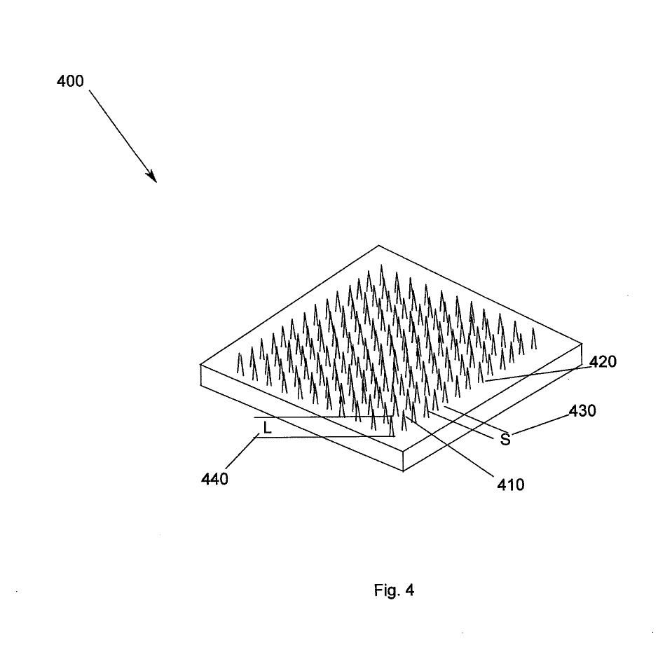

FIG. 4 shows an image of a carbon nanotube array 400 for use in a plasma limiter according to an embodiment of the present invention. Carbon nanotubes (CNTs) 410 exhibit superb field emission characteristics with high electrical conductivity, thermal conductivity, and field enhancement due to aspect ratio (tip radius/length). CNTs 410 may be grown on a variety of substrates 420, for example, using techniques such as carbon vapor deposition (CVD). Carbon nanotube arrays 400 can be aligned with an external electric field to create an intensely magnified electric field at the tips.

CNTs 410 have several advantages over metallic point electrodes for use in a plasma limiter. First, CNTs 410 could produce up to ten times the field enhancement of a metallic needle, thereby lowering the external electric field that is required for breakdown to initiate. CNTs 410 also have about ten times the thermal conductivity of the metals used in the current technology thereby helping to dissipate heat, increase the current carrying capacity, and reduce ablation. If tip ablation occurs on a CNT 410, the CNT 410 still possesses a high aspect ratio and field intensification factor, while tip ablation on a metallic needle severely diminishes its field intensification factor. Thus, field enhancers of CNTs 410 possess greater reliability and longevity than metallic needles.

In addition to these advantages, CNTs 410 have a turn-on voltage of around 10 kV/cm for electron emission, which is about one hundred times less than that of a typical metal point electrode. The electron emission capability of CNTs 410 may eliminate the need of active pre-ionization or radioactive electron sources that are often required with the current technology.

Furthermore, a CNT array 400 can be used to generate plasmas in atmospheric pressure air without significant degradation of the CNTs 410, thereby enabling a limiter that does not need a low-pressure inert gas to operate. Using atmospheric pressure air as the working gas in a limiter could decrease size, lower cost and increase reliability of the limiter. Overall, the use of a CNT array 400 as electrodes in plasma limiters significantly improve their transient voltage suppression capabilities thereby offering better protection for sensitive electronic equipment from EMP, HPM, and UWB.

Both the spacing, S 430, between carbon nanotubes 410 and the length, L 440, of the nanotubes have a significant impact upon the operation of the CNT array 400. If the carbon nanotubes 410 are placed too closely together, the nearby carbon nanotubes 410 effectively shield each other from the external electric field, reducing the field enhancement factor. On the other hand, moving the carbon nanotubes 410 further apart lowers the maximum current density that the array can handle. Longer carbon nanotubes 410 can produce higher field enhancement, but they also tend to be less well aligned than shorter carbon nanotubes 410, which can in turn reduce field enhancement due to a misalignment with the external electric field. Thus, the spacing, S 430, and length, L 440, of the carbon nanotube array 400 should be optimized.

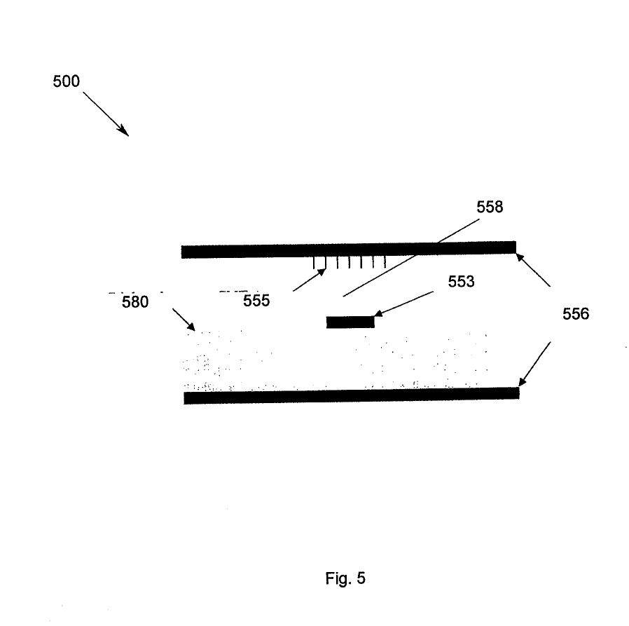

FIG. 5 shows a cross-section of a plasma limiter 500 implemented as a shielded microstrip line with a CNT array according to an embodiment of the present invention. The shielded microstrip line plasma limiter 500 includes a dielectric substrate 580, a signal line 553, and an air gap 558 between two ground planes 556. The CNT array 555 is disposed on a ground plane 556 across the air gap 558 from the signal line 553. The air gap 558 in the shielded microstrip line plasma limiter 500 may be filled with a low-pressure gas that is conducive to breakdown, such as a halogen gas.

In order to transmit a microwave signal with minimal attenuation, the impedance of the shielded microstrip plasma limiter 500 must be identical to the impedance of whatever transmission lines to which it is connected. Both the geometry of the transmission line 553 and the permittivity of the dielectric 580 affect the impedance.

The first step in determining the geometry of the shielded microstrip plasma limiter 500 involves determining the maximum operating frequency because the distance between the signal line 553 and the ground planes 556 should be less than 10% of the minimum wavelength to prevent the development of parasitic higher order modes. Secondly, the thickness of the air gap 558 will be set at a value that best facilitates breakdown. With these constraints in mind, the closed form impedance solution for a shielded microstrip will be used to choose a dielectric 580 with an appropriate permittivity, a thickness of the dielectric 580, and the width of the signal line 553 in order to achieve the desired impedance.

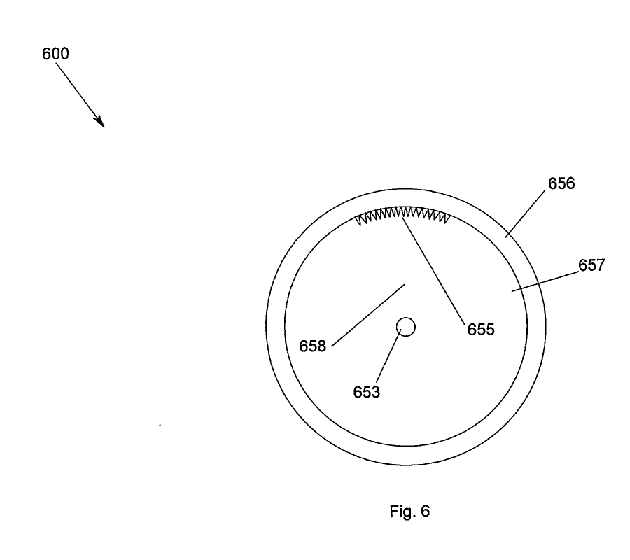

FIG. 6 is a crossection of a plasma limiter 600 implemented as a coaxial cable with a CNT array according to an embodiment of the present invention. In FIG. 6, the plasma limiter 600 includes a central signal line 653. The carbon nanotube array 655 may be coupled to the ground planes 656. A gap 658 is disposed between the carbon nanotube array 655 and the inner signal line 653. The interior 657 may be filled with a low-pressure gas that is conducive to breakdown.

Accordingly, FIGS. 5 and 6 indicated that the present invention is not meant to be limited to the type of implementation, i.e., microstrip, coaxial cable, etc. In fact, those skilled in the art will recognize that a plasma limiter according to an embodiment of the present invention may be implemented using a variety of transmission line types including waveguides, striplines, etc.

The foregoing description of the embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. A carbon nanotube plasma limiter, comprising:
a transmission line assembly having a signal line; and
a carbon nanotube device, coupled to the transmission line assembly across a gap, configured for enhancing an electric field to initiate a streamer breakdown process within the gap to cause a short circuit of the transmission line assembly in response to a predetermined energy pulse.

2. The carbon nanotube plasma limiter of claim 1 further comprising an inert gas disposed within the gap between the signal line and the carbon nanotube device.

3. The carbon nanotube plasma limiter of claim 1 further comprising air at atmospheric pressure disposed within the gap between the signal line and the carbon nanotube device.

4. The carbon nanotube plasma limiter of claim 1, wherein the carbon nanotube device further comprising an array of carbon nanotubes.

5. The carbon nanotube plasma limiter of claim 4, wherein the array of carbon nanotubes is configured to align with an external electric field to create an intensely magnified electric field at tips of the carbon nanotubes.

6. The carbon nanotube plasma limiter of claim 4, wherein the carbon nanotube array is grown on a conductive substrate.

7. The carbon nanotube plasma limiter of claim 4, wherein the carbon nanotube array is configured with a predetermined spacing between carbon nanotubes having a predetermined length.

8. The carbon nanotube plasma limiter of claim 1, wherein the transmission line assembly comprises a shielded microstrip line.

9. The carbon nanotube plasma limiter of claim 8, wherein the shielded microstrip line includes a dielectric substrate, a signal line, and an air gap formed between two ground planes.

10. The carbon nanotube plasma limiter of claim 8, wherein the shielded microstrip line is configured to provide a predetermined impedance.

11. The carbon nanotube plasma limiter of claim 1, wherein the transmission line assembly comprises a waveguide assembly.

12. The carbon nanotube plasma limiter of claim 1, wherein the transmission line assembly comprises a coaxial cable.

13. A method for providing a carbon nanotube plasma limiter, comprising:
providing a transmission line assembly having a signal line;
providing a carbon nanotube device to form a gap between the carbon nanotube device and the signal line of the transmission line assembly; and
configuring the carbon nanotube device for enhancing an electric field to initiate a streamer breakdown process within the gap to cause a short circuit of the transmission line assembly in response to a predetermined energy pulse.

14. The method of claim 13 further comprising providing an inert gas within the gap between the signal line and the carbon nanotube device.

15. The method of claim 13 further comprising providing air at atmospheric pressure within the gap between the signal line and the carbon nanotube device.

16. The method of claim 13, wherein the providing a carbon nanotube device further comprises providing an array of carbon nanotubes.

17. The method of claim 16, wherein the providing an array of carbon nanotubes further comprises configuring the array of carbon nanotubes to align with an external electric field to create an intensely magnified electric field at tips of the carbon nanotubes.

18. The method of claim 16, wherein the providing an array of carbon nanotubes further comprises growing a carbon nanotube array on a conductive substrate.

19. The method of claim 16, wherein the providing an array of carbon nanotubes further comprises configuring the carbon nanotube array with a predetermined spacing between carbon nanotubes having a predetermined length.

20. The method of claim 13 wherein the providing a transmission line assembly comprises providing a shielded microstrip line.

21. The method of claim 13 wherein the providing a transmission line assembly comprises providing a waveguide assembly.

22. The method of claim 13 wherein the providing a transmission line assembly comprises providing a coaxial cable.
